(19) United States
(12) Patent Application Publication
(10) Pub. No.: US 2003/0174962 A1
(43) Pub. Date: Sep. 18, 2003

(54) Low-loss optical fiber tap with integral reflecting surface

(76) Inventors: Craig D. Poole, Durham, NH (US); Cathy Shaw-Trumble, Barrington, NH (US)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/390,398

(22) Filed: Mar. 17, 2003

Related U.S. Application Data
(60) Provisional application No. 60/365,092, filed on Mar. 18, 2002.

(51) Int. Cl. G02B 6/26

(52) U.S. Cl. 385/48; 385/29

(57) ABSTRACT

An optical fiber tap for transferring optical energy out of an optical fiber comprising an optical fiber having an annealed microbend for coupling optical energy into cladding modes, a reflecting surface formed in cladding of the fiber and positioned at an angle for reflecting by total internal reflection, cladding mode energy away from the optical fiber. For use in an optical power monitor, the optical fiber tap is integrated into a standard electronic package containing a photodiode which converts tapped-out optical energy into an electrical signal representing the optical energy carried by the optical fiber.

### CLAIM TO PRIORITY

This application claims priority of our co-pending U.S. provisional application entitled “Low-Loss Optical Fiber Tap With Integral Reflecting Surface”, filed Mar. 18, 2002 and accorded serial No. 60/365,092; which is incorporated by reference herein.

### BACKGROUND OF THE INVENTION

1. Field of the Invention

This invention relates to a component for efficiently coupling optical energy out of an optical fiber, and particularly to an optical fiber tap that is low-loss, small in size, highly reliable and suitable for coupling to photodiodes for power monitoring applications in fiber optic systems.

2. Description of the Prior Art

The growth of optical fiber amplifiers and wavelength-division multiplexing (WDM) techniques in fiber optic systems has led to an increase in the number of active fiber optic components deployed in commercial telecommunications networks. In addition, the prospect of all-optical switching being used to route optical signals in these networks promises to further increase network complexity and component count. With these developments has come a need for monitoring devices that can provide information on the performance of optical networks in order to maintain performance levels and quickly address network faults when they occur. Such monitoring devices need to be highly reliable, low in cost, and small in size, with small size being of increasing importance as fiber optic equipment manufacturers compete to put increased functionality into ever-decreasing sized spaces.

One of the most important monitoring functions in fiber optic systems is monitoring optical power levels at various points in a fiber optic network. By monitoring optical power one obtains a good, though incomplete, indicator of system performance. For example, optical power is typically monitored both at input and output of optical fiber amplifiers to provide information on gain and saturation of the amplifier. In many cases optical power from the laser that pumps the amplifier is also monitored. Another example is monitoring optical power entering a receiver, this being necessary to insure that the receiver does not become saturated and its performance degraded. A further example is monitoring of optical power entering and leaving through ports of an optical switch in order to confirm integrity of optical paths.

Known devices for monitoring the optical power being carried by an optical fiber require the use of a tap to remove a small fraction of the optical power traveling through the fiber. Tapped-out light is typically sent to a photodiode that converts an optical signal to an electrical signal which is then processed electronically. Provided the ratio of optical power removed from the fiber to optical power remaining in the fiber is a fixed number, the electrical signal generated by the photodiode can serve as a measure of the optical power flowing in the fiber. Ideally, most of the optical power entering the tap passes through to its output and remains in the fiber and hence is unaffected by its presence.

Among known fiber optic taps, by far the most common is a fused fiber optic coupler formed by fusing two optical fibers together. In such a device, cores of the two fused fibers are sufficiently close in proximity that light traveling in one fiber is partially transferred to the other fiber, the former fiber being referred to as the “through leg” and the latter being referred to as the “tap-leg”. In monitoring applications, the light in the tap-leg, which is typically of less power than the light in the through-leg, is sent to a photodiode to generate an electrical signal. Fused fiber couplers are well known in the art and have been made to exhibit a variety of properties (see, for example, U.S. Pat. Nos. 4,426,215, 5,011,251 and 5,251,277).

Fused fiber couplers, when used in power monitoring applications, suffer from a number of disadvantages. First among these involves a necessity of terminating four fiber ends (two ends for each fiber). A power monitor is a three port device consisting of an optical input, an optical output and an electrical output. When constructing power monitors using fused fiber couplers it is necessary to terminate the tap-leg to the photodiode and also terminate the unused input port. In manufacturing fiber optic components, termination of fiber ends is a significant contributor to labor costs. Hence, having an extra termination disadvantageously adds to the cost of the device.

A second disadvantage of fused fiber couplers is their physical size. Although their packaging volume can be small, fused fiber couplers tend to be elongated in one dimension owing to the need to fuse the two fibers together over sufficient length to obtain the desired coupling without inducing significant loss. This puts a practical lower limit on the size of fused fiber couplers and makes integration into small opto-electronic modules rather difficult. In addition, termination of the tap-leg to a photodiode for monitoring optical power requires a further increase in the longest package dimension. A still further limitation on the physical size of fused fiber couplers involves a need to add a protective housing and substrate for the fibers after they are fused together owing to the fragile condition of the fused fibers.

Another known approach for forming an optical fiber tap is to induce a microbend in the fiber. The microbend causes a fraction of optical power to scatter out of a side of the fiber. In power monitoring applications, the scattered light is directed onto a photodiode by means of mirrors or lenses. Examples of optical fiber taps using micro-bending are given in U.S. Pat. Nos. 5,037,170, 5,039,188 and 5,708,265. A primary disadvantage of these optical taps is caused by a need for additional optical components to collect the light that emerges from the side of the fiber and direct it onto a photodiode. This feature makes integrating these devices into packages with photodiodes difficult and thus costly.

Another known approach for making an optical fiber tap involves exposing the core of an optical fiber by cutting a notch through the cladding of the fiber and into the core using laser ablation as described in U.S. Pat. Nos. 4,710,605, 4,712,858 and 5,500,913. This approach, though suitable for multi-mode fiber applications, is difficult in practice to implement with a standard single-mode fiber owing to a tendency of an ablating laser beam to distort the core and thus induce excessive loss of a transmitting signal. In addition, this approach usually induces unacceptable levels of back-reflected optical power due to a glass/air interface created by the notch. The back-reflected power can have a deleterious affect on performance of fiber optic systems.

An additional disadvantage resulting from forming an optical fiber tap by cutting a notch into the fiber core relates to a property called directivity. Directivity describes a tendency of a device to operate differently depending on the direction of flow of optical power. In many applications employing optical fiber taps, it is desirable that optical power be tapped-out only when that power flows in a desired direction. When optical power flows in an opposite direction, little or no optical power should emerge from the tap. A ratio of optical power emerging from the tap for forward directed power relative to backward directed power is referred to as directivity of the tap. Devices with high directivity are usually more desirable because they allow a user to distinguish a source of the optical power being tapped-out as flowing in either a forward or backward direction. Techniques for making optical fiber taps that cut a notch into the fiber core necessarily tap optical power out regardless of the direction of flow of optical power. This leads to poor directivity and thus makes these techniques unattractive in many applications.

Another known technique for making an optical fiber tap is described in published U.S. patent application Ser. No. 09/794,876, in which an optical fiber is encapsulated by a glass sleeve having a polished face on one end. Optical power in the fiber core is first launched into the cladding of the fiber by one of various techniques including tapering or bending of the fiber. Optical power in the cladding is then coupled into the surrounding glass sleeve and reflected out in a direction transverse to the fiber length by the polished face on the sleeve using total internal reflection. This technique, though resulting in a tap that is compact in size, suffers from manufacturing difficulties owing to a need to slide a glass sleeve over the fiber; a process that is labor intensive and can adversely affect strength and thus reliability of the fiber.

### SUMMARY OF THE INVENTION

An object of the present invention is to provide an optical tap that is efficient, reliable, highly directional, and small enough in size to be readily integrated into miniature opto-electronic packages.

The present invention accomplishes this by using laser ablation to form a reflecting surface directly in the outer cladding of a single-mode fiber without adversely affecting the core of the fiber. Optical energy is tapped-out of the optical fiber by exciting cladding modes in the fiber just upstream of the reflecting surface. Specifically, in one embodiment, cladding modes in the fiber are excited by inducing an annealed microbend using laser heating of the fiber. Optical power in the cladding modes is reflected out of the fiber by the reflecting surface at an approximate angle of 90 degrees to the fiber axis thus making collection onto a photodiode for monitoring purposes relatively easy and efficient.

Furthermore, in accordance with our inventive teachings, the single-mode fiber has a notch cut into its outer cladding using CO₂ laser radiation to create a reflecting surface, and a micro-bend formed in the fiber upstream of the reflecting surface to couple a predetermined amount of optical energy out of the core of the fiber to be incident on the reflecting surface. The notch is cut into the cladding of the fiber so as to create a reflecting surface at an angle of approximately 44 degrees to a perpendicular of the fiber axis, thus inducing total internal reflection for light propagating in the cladding of the fiber.

According to our inventive technique, a device for monitoring optical power in an optical fiber is made by integrating the optical tap into a photodiode package so that optical power that is reflected out of the optical fiber falls onto a photodiode, thus generating an electrical signal that represents the optical power flowing through the fiber.

A further inventive embodiment utilizes a multi-fiber monitor array in which a plurality of power monitors, each formed using our inventive optical tap, are welded together to form a single device for simultaneously monitoring optical power in each of a plurality of optical fibers.

An additional embodiment involves a fiber optic tap formed in polarization maintaining fiber by aligning the notch and micro-bend to be coincident with a polarization axis of the fiber.

Furthermore, our inventive teaching can be used to form bi-directional fiber optic tap utilizing two reflecting surfaces formed in the outer cladding of a single-mode fiber, through laser ablation, and separated by a single micro-bend formed using laser heating.

In accordance with our inventive teaching, a device for simultaneously monitoring optical power flowing in both directions within an optical fiber can be made by integrating the bi-directional optical tap into a photodiode package containing two detectors so that one detector selectively measures optical power flowing in an upstream direction and the other detector measures optical power flowing in a downstream direction.

### BRIEF DESCRIPTION OF THE DRAWINGS

The teachings of the present invention can be readily understood by considering the following detailed description in conjunction with the accompanying drawings in which:

FIG. 1 depicts a side view of an embodiment of our inventive optical fiber tap 100;

FIG. 2 depicts a block diagram of apparatus 200 for fabricating the optical fiber tap shown in FIG. 1;

FIG. 3 depicts a graph of notch depth plotted as a function of a number of laser passes;

FIG. 4 depicts a graph of tap ratio of the optical fiber tap of FIG. 1 plotted as a function of notch depth;

FIG. 5 depicts a graph of an angle of reflecting surface 106 shown in FIG. 1 plotted as a function of notch depth;

FIG. 6 depicts a graph of tap ratio of the optical fiber tap of FIG. 1 plotted as a function of distance between microbend and notch;

FIG. 7 depicts a graph of tensile strength of a single-mode fiber plotted as a function of notch depth;

FIG. 8 depicts a graph of tap ratio of the optical fiber tap shown in FIG. 1 plotted as a function of wavelength for several different macro-bend radii;

FIG. 9 depicts a cross-sectional view of power monitor 900 constructed using optical fiber tap 100 shown in FIG. 1;

FIG. 10 depicts a cross-sectional view of power monitor 1000 constructed using optical fiber tap 100 shown in FIG. 1;

FIG. 11 depicts a side view of our inventive wavelength selective optical fiber tap 1100;

FIG. 12 depicts a side view of another embodiment 1200 of our inventive wavelength selective optical fiber tap;

FIG. 13 depicts a side view of our inventive bi-directional optical fiber tap 1300;

FIGS. 14a and 14b depict top and end-on plan views, respectively, of our inventive optical power monitor array 1400; and

FIG. 15 depicts a side view of our inventive polarization maintaining optical fiber tap 1500.

To facilitate reader understanding, identical reference numerals are used to denote identical or similar elements that are common to the figures. The drawings are not necessarily drawn to scale.

### DETAILED DESCRIPTION OF THE PREFERRED EMBODIMENT

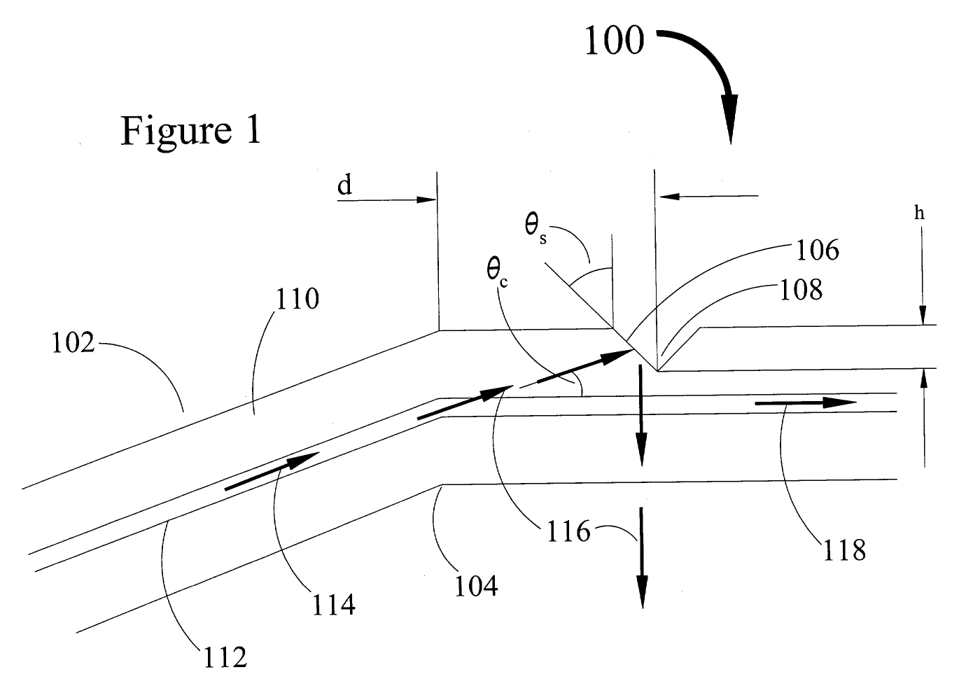

Referring to the drawings, FIG. 1 depicts fiber optic tap 100 comprising optical fiber 102, microbend 104 and reflecting surface 106. Reflecting surface 106 is formed when v-shaped notch 108 is created by ablating a portion of the fiber cladding 110 using pulsed radiation from a CO₂ laser.

In the following description of the operation of optical tap 100, optical fiber 102 is assumed to comprise central core 112 of refractive index n1 surrounded by cladding 110 having a lower refractive index n₂. In some embodiments, either or both the core and cladding may have refractive index profiles of varying complexity and shape. Further, it is assumed that optical energy 114 flowing in optical fiber 102 is in a guided mode of the fiber prior to entering optical tap 100. As is well known in the art, light is said to be in a guided mode when radial distribution of its energy remains fixed as the light propagates along a length of an optical fiber. The majority of optical energy of such guided modes is also typically located within a higher-index core region of an optical fiber. By contrast, light is said to be in a cladding mode of an optical fiber when its radial distribution of energy changes as it propagates along the length of a fiber. In addition, light that is in a cladding mode typically has a majority of its optical energy in the lower index cladding that surrounds the core.

As shown in FIG. 1, guided optical energy 114 encounters microbend 104 upon entering optical tap 100. Microbend 104 is formed in optical fiber 102 by locally applying heat using a CO₂ laser while holding fiber 102 in a curved trajectory as described below. In the description given here, a microbend refers to a bent section of fiber having radius of curvature comparable to the diameter of the fiber. In contrast, a macrobend refers to a bend having radius of curvature that is large compared to the diameter of the fiber.

Returning to FIG. 1, microbend 104 scatters a small fraction of optical energy 114 at an angle θ_{c}, via optical energy 116, into one or more, cladding modes of fiber 102, while leaving the majority of optical energy 114, via optical energy 118, in the guided mode. Optical energy 116 that is scattered into the cladding of fiber 102 by microbend 104 is reflected downward by reflecting surface 106 located a distance d downstream. Preferably, reflecting surface 106 is formed at an angle θₛ as shown in FIG. 1, where θₛ is greater than or equal to an angle for total internal reflection. As is well known in the art, the angle for total internal reflection θₜ is determined by the refractive index n₂ of fiber cladding 110 and the refractive index nₛ of the medium surrounding fiber 102 and is expressed by the formula θₜ=arcsin(nₛ/n₂) . For example, for an optical fiber with undoped silica cladding surrounded by air, the angle θₜ for total internal reflection is approximately 44 degrees. Thus, assuming scattering angle θ_{c} is small, angle θₛ should be formed to have an angle greater than or equal to approximately 44 degrees.

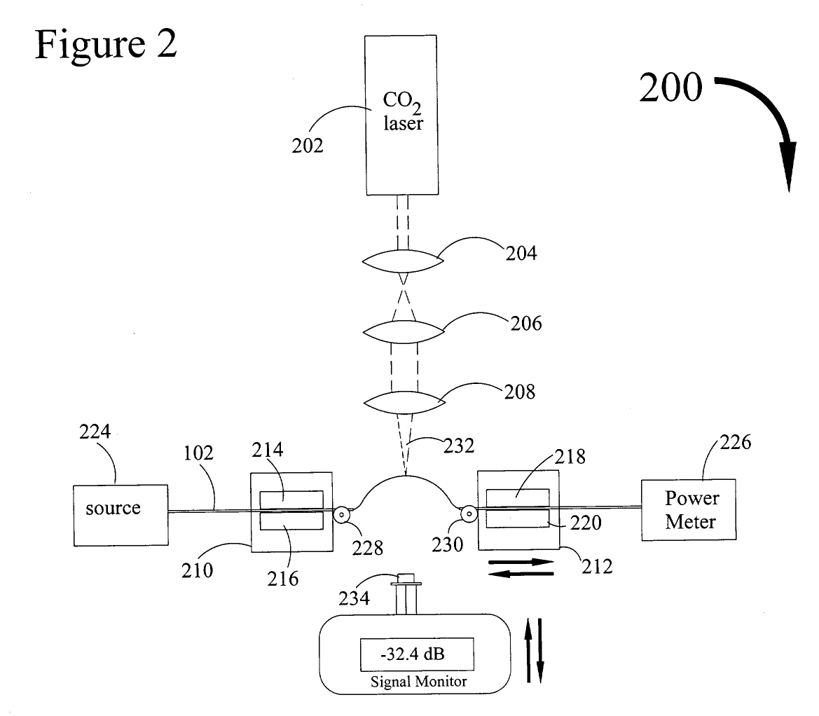

Optical tap 100 is fabricated using apparatus 200 depicted in FIG. 2. Also, radiation from CO₂ laser 202 is directed through lens 204, 206 and 208 which collectively condition and focus the laser radiation onto optical fiber 102. Optical fiber 102 is held in focused beam 232 by clamping fixtures 210 and 212, each of which holds the fiber by sandwiching it between clamping plates 214, 216 and 218 and 220, respectively. A clamping force applied to fiber 102 by clamping fixtures 210 and 212 is adjusted so as to avoid inducing loss in the fiber while maintaining sufficient force to hold the fiber in place.

Prior to mounting in the clamping fixtures, optical fiber 102 has a portion of its protective jacket removed to expose a length of bare cladding. The exposed cladding section is then positioned in the region between clamping fixtures 210 and 212.

Optical power from laser source 224 is coupled into fiber 102 while power meter 226 measures an amount of optical power emerging from fiber 102.

After mounting fiber 102 in clamping fixtures 210 and 212, and prior to applying radiation from CO₂ laser 202, fiber 102 is flexed to form a macrobend by moving clamping fixture 212 toward clamping fixture 210. Fiber guides 228 and 230 cause the fiber to bend in the direction of the laser radiation. Preferably, the macrobend induced in fiber 102 should be of sufficiently small radius to provide stress in the fiber that is greater than any residual stress caused by accidental twists or flexing of the fiber in the clamping fixtures, while at the same time minimizing excess loss in the fiber. For example, a bend radius of approximately 0.5 inches usually satisfies this condition for Corning SMF-28 single-mode fiber.

Focussed radiation from CO₂ laser 202 is applied to the bent section of fiber 102 while optical power is measured by power meter 226. Through absorption of the optical energy from CO₂ laser 202, glass of fiber 102 is heated above its softening temperature forming permanent microbend 104 (see FIG. 1) in the fiber. By adjusting laser beam parameters such as focal spot size, power level, and time of exposure, the microbend that is formed can be made to scatter a predetermined fraction of optical power from the core of fiber 102 into the cladding as measured by the change in transmitted power using power meter 226. Preferably, the focal spot size should be adjusted to be comparable to a diameter of the fiber to minimize an extent of an affected region on the fiber and keep the induced microbend radius as small as possible. In this way multi-path affects are avoided that otherwise could lead to polarization dependence in the tap. For example, using a focal spot size of 400 micron, a power level of 3.5 Watt from a CO₂ laser operating at 10.6 micron wavelength induces a 0.5 dB loss in Corning SMF-28 single-mode fiber held in a 0.5 inch radius bend in 1 second of exposure.

After forming microbend 104, clamping fixture 212 is moved back to its starting position to release the stress in fiber 102. Using clamping fixtures 210 and 212, fiber 102 is then moved to position the laser beam from laser 202 onto a point on fiber 102 a small distance from microbend 104 in the direction away from source 224. Lenses 206 and 208 are then moved to readjust the size of the focus. Laser radiation is applied to fiber 102 to form notch 108 by pulsing the laser at a predetermined rate while moving fiber 102 through the focal region. To form a v-shaped notch in the cladding of fiber 102, the laser power level, focal spot size and pulse duration are adjusted so that the temperature of the cladding glass of fiber 102 is raised above the temperature required to vaporize the glass material in a small region. After forming the notch, the optical power reflected out of the side of the fiber is measured using photodetector 234.

In order to minimize excessive melting of a region surrounding the notch and thus avoid excess loss caused by distortion of the fiber core, large peak power density levels and short duration pulses should be used. For example, “Laser-fabricated fiber-optic taps”, by K. Imen et al, OPTICS LETTERS, Vol. 15, No. 17, Sep. 1, 1990, pp. 950-952, states that a pulse duration of greater than 10 msec can induce noticeable melting of the region surrounding a laser machined notch in multi-mode fiber. In single-mode fiber, where even small amounts of melting of the core can induce measurable losses, it is preferable to maintain pulse duration below 1 msec.

For the results reported here, a CO₂ laser having 100 Watt peak power, pulse duration of 50 microseconds, focal spot size of approximately 50 micron and power density at the surface of the fiber of approximately 5 million Watts/cm2 was used to form notch 108 of FIG. 1. In order to obtain the desired angle for reflecting surface 106 of FIG. 1, the laser was pulsed at approximately 1 pulse per second while traversing fiber 102 across the beam at a rate of approximately 12 micron per second. With this scan rate and pulse rate, approximately 10 pulses impacted the fiber on each pass. It should be noted that the process for forming optical tap 100 can be readily adapted to a fully automated manufacturing process in which taps are formed at multiple points along the length of a single fiber. By manufacturing multiple taps in a single fiber span, ensuing cost of manufacture can be greatly reduced by avoiding a need to terminate fiber ends for each tap.

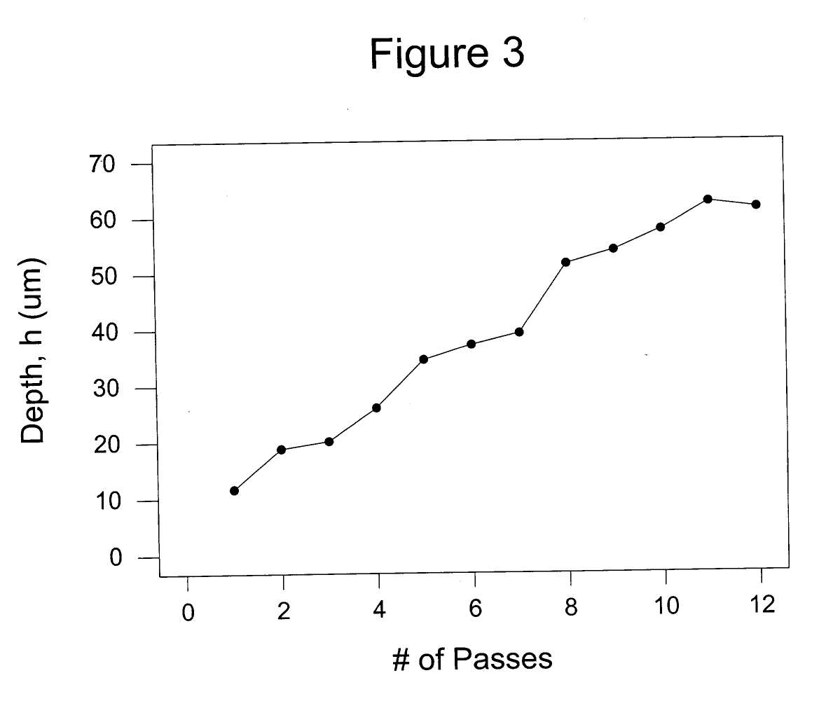

FIG. 3 depicts a graph of notch depth versus number of passes made on a standard single-mode fiber (specifically, Corning SMF28). It was found that after 12 passes the notch just began to enter the fiber core. Prior to a last pass, there was no measurable change in the loss of the fiber, thus indicating that deformation of the core had not occurred even with the notch depth within 2 micron of the core.

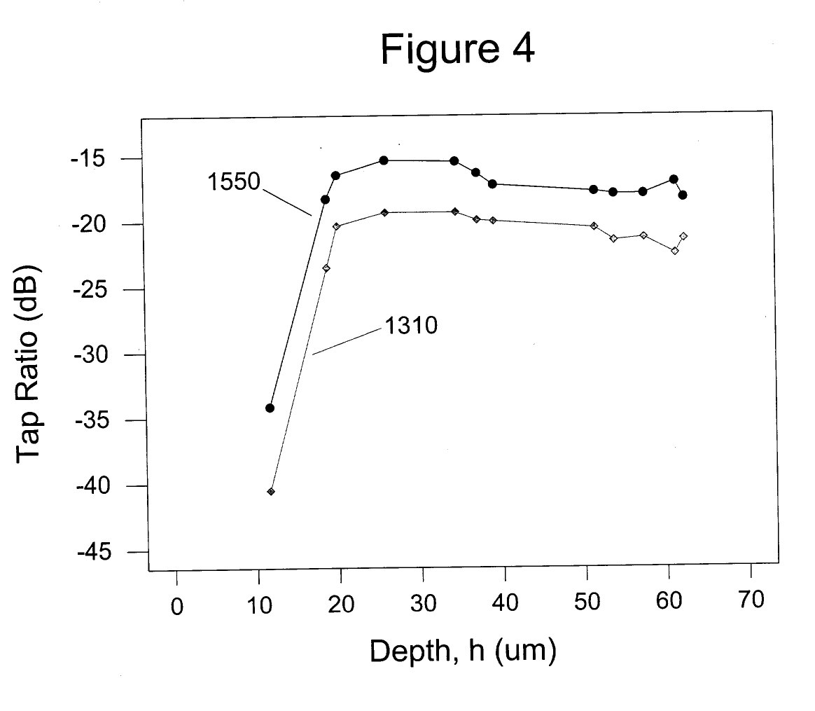

FIG. 4 depicts a graph of tap ratio versus notch depth for a tap of the design of FIG. 1 made in a single-mode fiber (Corning SMF28). The tap ratio plotted in FIG. 4 is defined as the ratio of optical power coupled out of the side of the fiber by reflecting surface 106 (shown in FIG. 1) to optical power propagating through the fiber to its output. A microbend that was formed prior to making the notch coupled 6% of the optical power into the cladding. The notch was formed 2 mm downstream of the microbend and the tap ratio measured after each pass of the laser. This graph shows that a maximum tap ratio is achieved at 1550 nm and 1310 nm at a depth of approximately 25 to 30 micron.

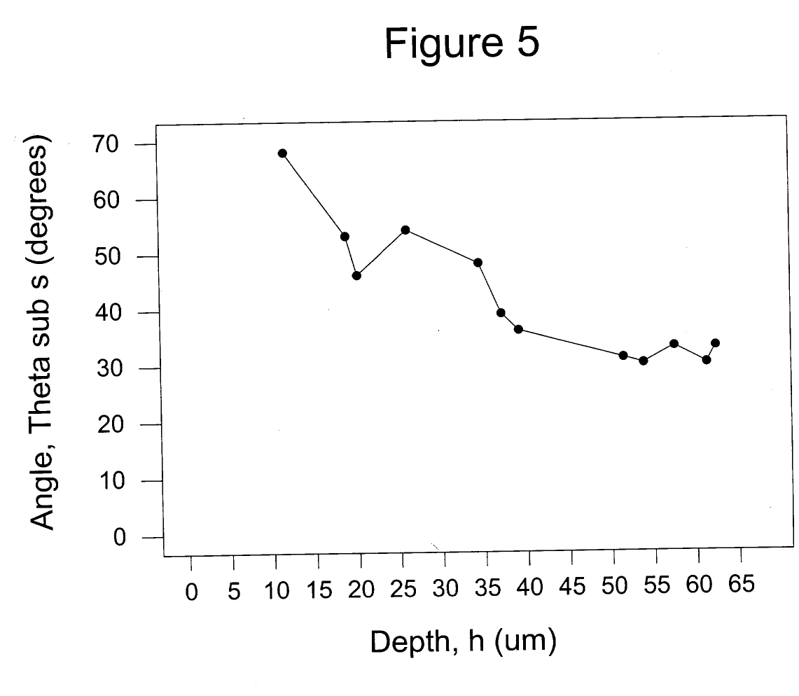

FIG. 5 depicts a graph of angle θₛ of reflecting surface 106 (see FIG. 1) versus notch depth measured in a single-mode fiber subjected to multiple passes under the CO₂ laser as previously described. The shape of the notch and thus the angle of reflecting surface 106 changes with the depth of the notch. As a result, for notch depths greater than approximately 35 micron, the angle drops below the critical angle of 44 degrees for total internal reflection resulting in a drop in the tap ratio with increasing depth shown in FIG. 4.

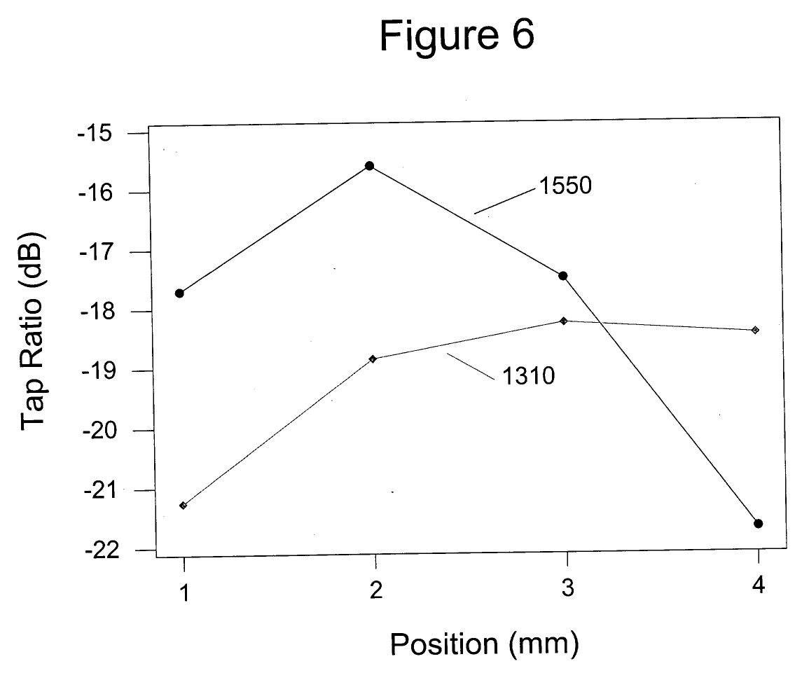

Referring to optical tap 100 shown in FIG. 1, distance d between microbend 104 and reflecting surface 106, as well as the depth of notch 108, are selected to maximize the optical energy that impinges on reflecting surface 106. FIG. 6 depicts a graph of tap ratio versus distance d for a tap with microbend induced coupling to the cladding of 6%. This graph shows an optimum distance for 1550 nm and 1310 nm wavelengths of approximately 2 mm and 3 mm, respectively.

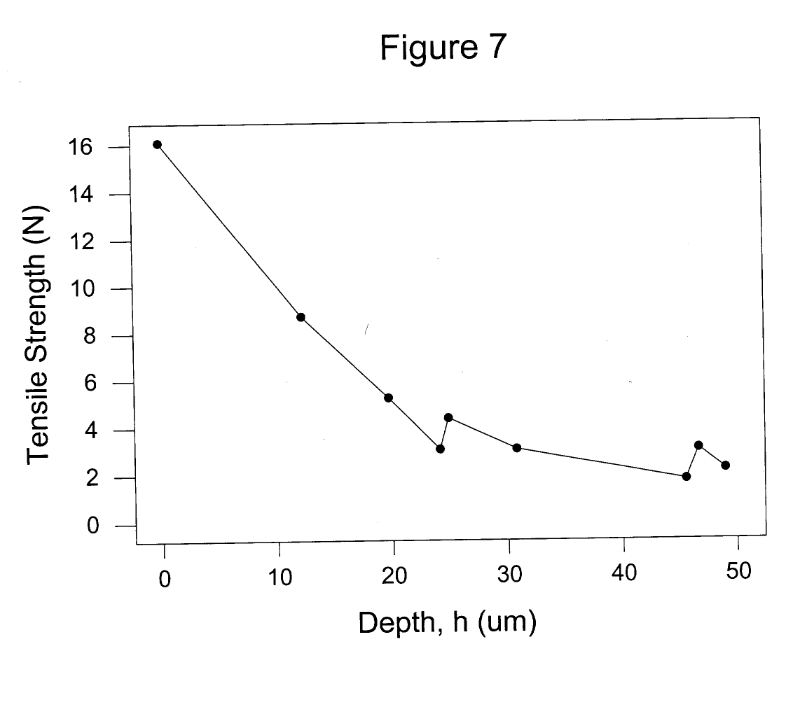

FIG. 7 depicts a graph of tensile strength of Corning SMF28 single-mode fiber versus notch depth for a collection of fibers cut to varying notch depths. This graph shows the tensile stress at which each fiber broke. In all these cases, the fiber broke at the notch. Although FIG. 7 shows that forming a notch reduces the strength of the fiber, the reduction in strength is only moderately more than would be expected based on the asymmetrical geometry of the notch and reduction in cross-sectional area due to removal of the cladding material.

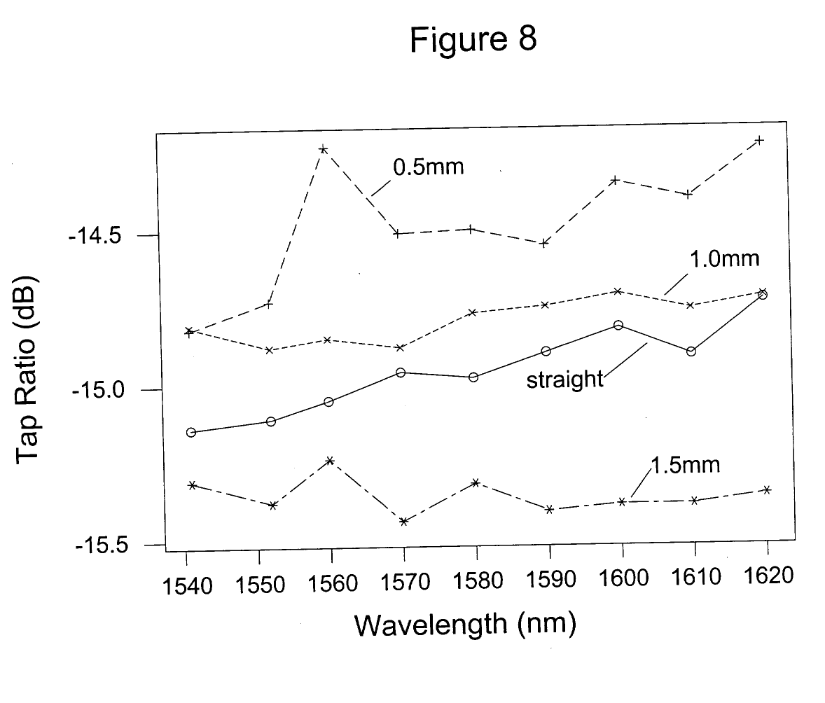

FIG. 8 depicts a graph of wavelength dependence of tap ratio versus bend radius for an optical fiber tap subjected to macrobends of varying radii. The macrobends were induced after formation of the tap by moving clamping fixture 212 toward clamping fixture 210 of FIG. 2 so as to flex the fiber in the region of the tap. Flexing the fiber to form a macrobend changes the angle θ_{c} of cladding mode power shown in FIG. 1 and thus the coupling efficiency of reflecting surface 106. The graph in FIG. 8 shows that the wavelength dependence and coupling efficiency can be tuned by varying the macrobending of the optical fiber tap. For example, for a bend radius of 0.42 meter a nearly flat spectral response from 1541 to 1620 nm is achieved while the straight fiber shows more than 0.5 dB variation.

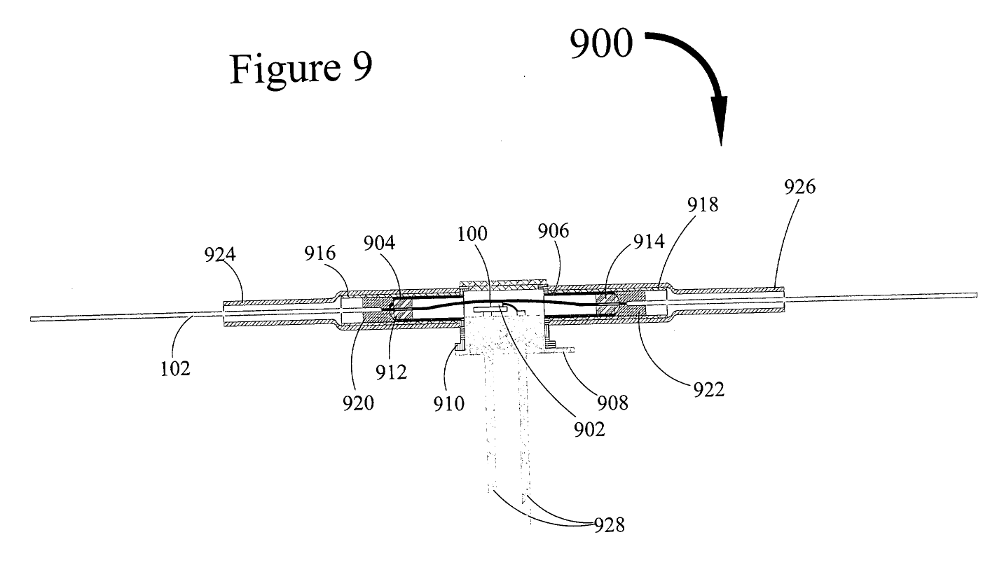

According to our inventive teachings, optical tap 100 of FIG. 1 can be easily integrated into opto-electronic packages to make in-line fiber optic power monitors. FIG. 9 depicts a cross-sectional view of optical power monitor 900 comprising optical tap 100, photodiode 902, input and output metal tubes 904 and 906, respectively, metal cap 910, header 908, and electrical leads 928. Metal tubes 904 and 906, metal cap 910 and header 908 are brazed or welded together in order to provide a hermetic seal at their joints. Optical fiber tap 100 and photodiode 902 are hermetically sealed within metal cap 910 using glass solder 912 and 914 to form a seal between the fiber and the inner walls of metal tubes 904 and 906. Glass solder seals are well known in the art and are formed by heating metal tubes 904 and 906 above the melting temperature of the glass solder using either induction heating or laser heating.

Outer tubes 916 and 918 are secured over metal tubes 904 and 906, respectively, using epoxy to provide protection for fiber 102. Additional epoxy 920 and 922 and heat shrink tubing 924 and 926 provide further support and protection for optical fiber 102.

Light coupled out of optical tap 100 strikes a photosensitive surface of photodiode 902 creating an electrical signal that is carried by electrical leads 928. Because the ratio of optical energy incident on photodiode 902 relative to the optical energy carried by fiber 102 is fixed, the electrical signal carried by electrical leads 928 can be used as a measure of the optical energy flowing in optical fiber 102.

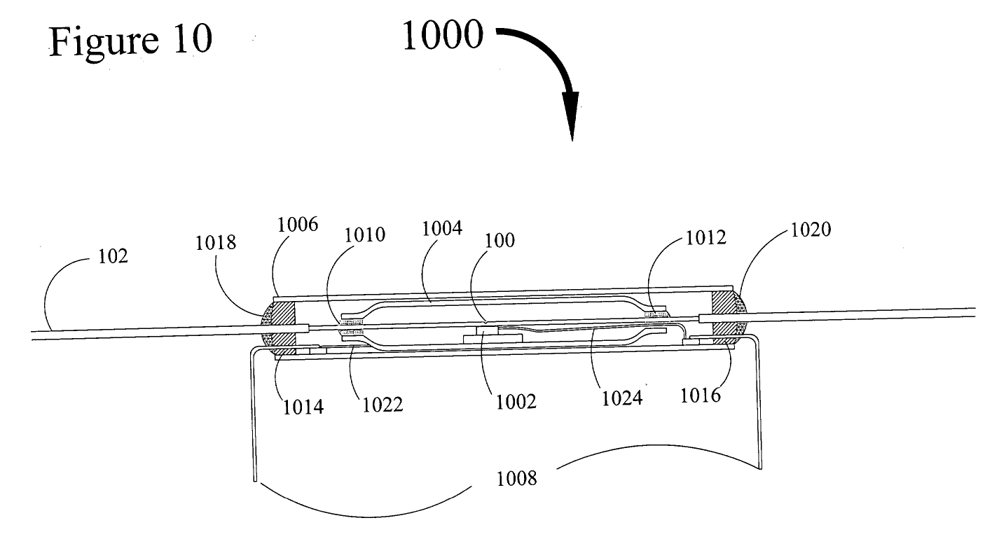

FIG. 10 shows a cross-sectional view of alternative optical power monitor 1000 comprising optical tap 100, photodiode 1002, inner metal tube 1004, outer metal tube 1006, and electrical leads 1008, 1022 and 1024. Optical fiber tap 100 and photodiode 1002 are hermetically sealed within inner tube 1004 using glass solder 1010 and 1012 to form a seal between the fiber and the inner walls of inner tube 1004. Additionally, glass solder 1012 serves to form a hermetic seal around electrical lead 1024.

Outer tube 1006 is secured over inner tube 1004 using epoxy. Additional epoxy 1014 and 1016 and silicone beads 1018 and 1020 provide further support and protection for optical fiber 102.

Light coupled out of optical tap 100 strikes the photosensitive surface of photodiode 1002 creating an electrical signal that is carried by electrical leads 1022, 1024 which, in turn, are connected to leads 1008.

The advantage of optical power monitor 1000 of FIG. 10 when compared to optical power monitor 900 of FIG. 9 is the need for only two hermetic seals. This is accomplished by hermetically sealing both the optical and electrical leads using glass solder 1010 and 1012 in the same feed-through. Since the cost of manufacturing fiber optic devices is affected by the number of hermetic seals required, power monitor 1000 advantageously reduces this cost. In addition, power monitor 1000 is more readily suited to forming arrays of devices, as will be described below.

Additional Embodiments

Additional embodiments of our inventive optical tap 100 can be realized by using alternative methods for coupling light into the cladding of the fiber as described in published U.S. patent application Ser. No. 09/794,876. Among these are offset fusion splices, tapering of the fiber and fiber gratings.

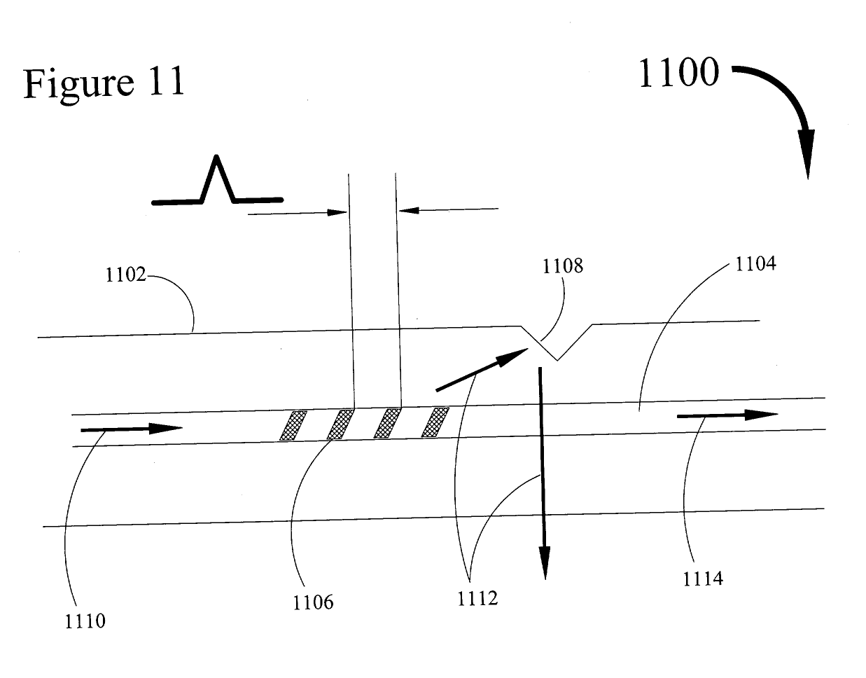

An additional embodiment of optical tap 100 that is wavelength selective is depicted in FIG. 11. Wavelength-selective optical taps are useful in wavelength divisional multiplexing (WDM) applications for monitoring specific wavelength channels while excluding other channels. Wavelength selective optical tap 1100 comprises optical fiber 1102, fiber core 1104, photo-induced grating 1106 and reflecting surface 1108. Optical power 1110 entering optical fiber tap 1100 encounters grating 1106 which scatters a fraction of optical power 1112 into the cladding while leaving a majority of optical energy 1114 in the guided mode. Cladding optical power 1112 reflects off of reflecting surface 1108 and is directed out of the side of fiber 1102.

The coupling of optical power into the cladding by periodic grating 1106 occurs at a wavelength λ_{c} determined by the spatial period of the grating Λ, the effective index of the guided mode n_{g}, and the effective index of the cladding mode n_{c} (see, for example, pages 61-81 of D. Marcuse, Light Transmission Optics (© 1989, Krieger Publishing Co., Inc., Malabar, Fla.). In particular, maximum coupling occurs when the following phase matching condition is met: n_{g}−n_{c}=λ_{c}/Λ. Power monitors that have optical taps which are constructed using gratings to couple optical power into the cladding would selectively measure the optical power within a single band of wavelengths. As is well known in the art, these gratings can be created by a variety of methods including periodic deformation of the fiber core according to the teachings of U.S. Pat. No. 5,411,566, or as shown in FIG. 11, by a permanently induced phase grating using the teachings of U.S. Pat. No. 5,647,039.

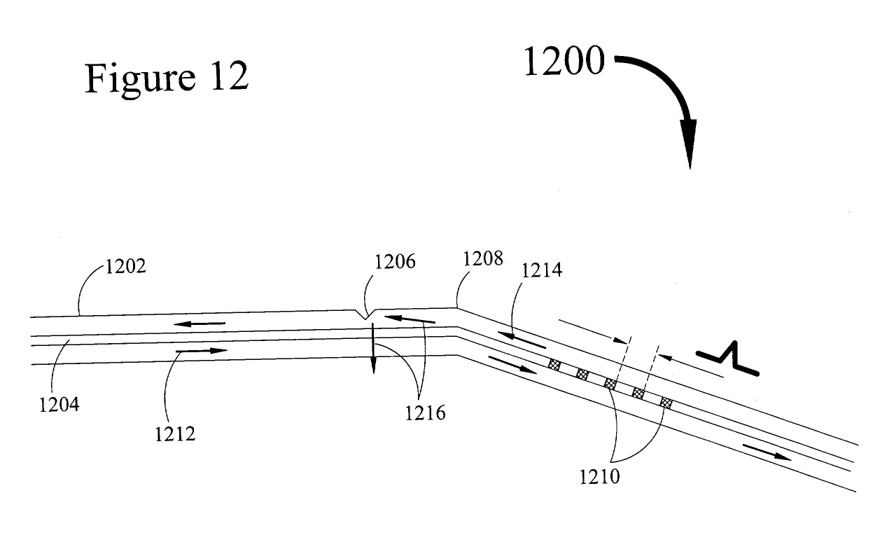

An alternative method of achieving a wavelength selective tap that makes use of the directional nature of tap 100 of FIG. 1 is depicted in FIG. 12. Wavelength selective tap 1200 comprises optical fiber 1202, fiber core 1204, reflecting surface 1206, microbend 1208 and fiber grating 1210. The majority of optical power 1212 entering the tap region passes downstream of reflecting surface 1206 and microbend 1208 where it encounters permanent phase grating 1210. That portion of optical power 1212 having wavelength matched to grating period Λ is reflected back toward microbend 1208. Microbend 1208 scatters a portion of reflected optical power 1214 into the cladding. Resulting scattered energy 1216 is then reflected out of the fiber by reflecting surface 1206. Wavelength selective tap 1200 thus only taps out optical power of wavelength matched to grating 1210. The loss induced by microbend 1208 and the strength of grating 1210 can be adjusted to remove more or less of guided optical energy 1212.

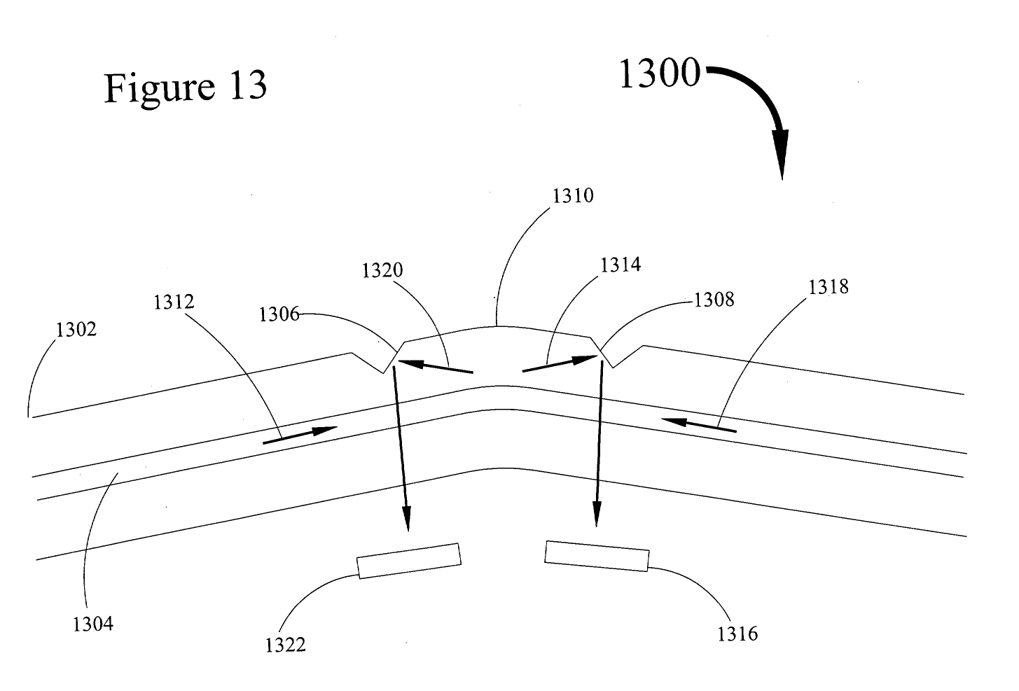

An additional embodiment that makes use of our inventive teachings to simultaneously measure the optical power flowing in both directions within a fiber is shown in FIG. 13. Here, bi-directional optical fiber tap 1300 comprises optical fiber 1302, fiber core 1304, reflecting surfaces 1306 and 1308 and microbend 1310. Forward propagating optical power 1312 passes downstream of reflecting surface 1306 where a small fraction of this power, shown as power 1314, is scattered into the cladding. Scattered optical power 1314 encounters reflecting surface 1308 and is reflected out of fiber 1302 where it is detected by photodiode 1316. The electrical signal generated by photodiode 1316 is useful as a representation of forward propagating optical power 1312.

Simultaneously, backward propagating optical power 1318 encounters microbend 1310 where a small fraction of that optical power, shown as power 1320, is scattered into the cladding. Optical power 1320 is reflected by reflecting surface 1306 out of the fiber and onto photodiode 1322. The electrical signal generated by photodiode 1322 is useful as a representation of backward propagating optical power 1318. In this way bi-directional optical tap 1300 simultaneously measures optical power flowing in both directions within fiber 1302.

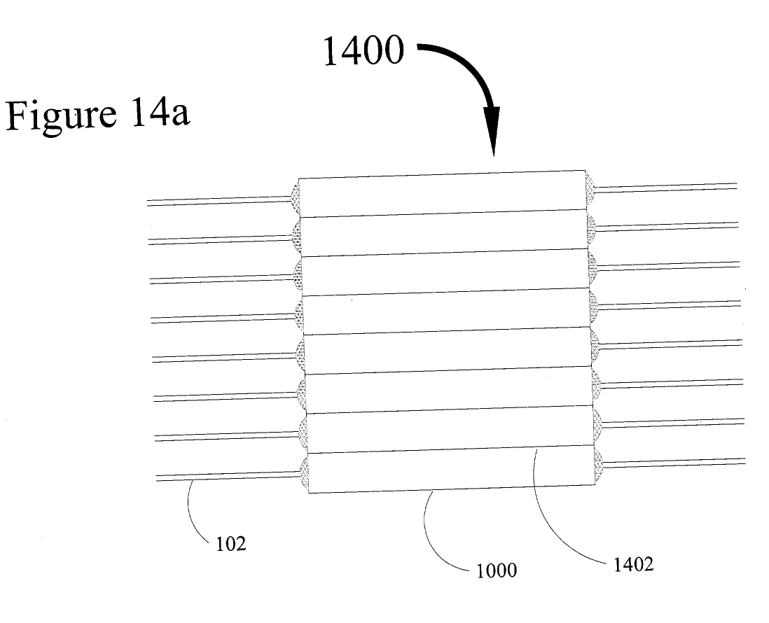

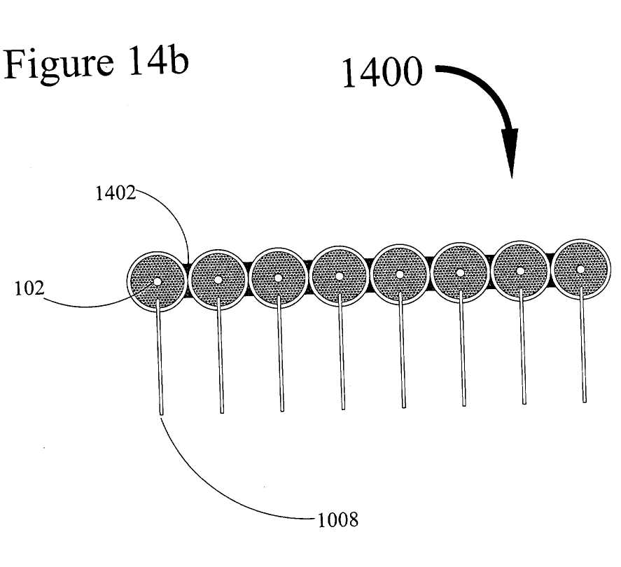

FIGS. 14a and 14b show top and end-on plan views, respectively, of an additional embodiment that makes use of power monitor 1000 of FIG. 10 to form a power monitor array that incorporates multiple taps into a single package. Power monitor array 1400 comprises a plurality of power monitors identical to power monitor 1000 of FIG. 10 welded together to form a single device for monitoring the optical power carried by a plurality of optical fibers 102. Weld joints 1402 shown in FIG. 14b, are formed by resistance welding the outer tubes of the individual power monitors together. The miniature size of optical tap 100 of FIG. 1 and correspondingly small size of power monitor 1000 of FIG. 10 allow a relatively large number of power monitors to be incorporated into a single package for simultaneously monitoring a plurality of fiber channels.

Optical Taps Made with Alternative Fiber Types

The preferred embodiment described hereinabove utilizes standard telecommunications single-mode fiber. However, our inventive teachings can apply equally well to other types of optical fiber. Specifically, optical fiber tap 100 shown in FIG. 1 can be readily implemented in polarization maintaining fiber. Polarization maintaining fiber, such as that described in U.S. Pat. No. 4,478,489 ('489 patent), has a property of maintaining the state of polarization of light as it propagates in the fiber. Standard telecommunication fiber on the other hand does not restrict the state of polarization of light and thus the polarization of light will vary in an undetermined way as it propagates along its length. Maintaining the state of polarization is useful in applications where the performance of optical devices rely on a predetermined state of polarization.

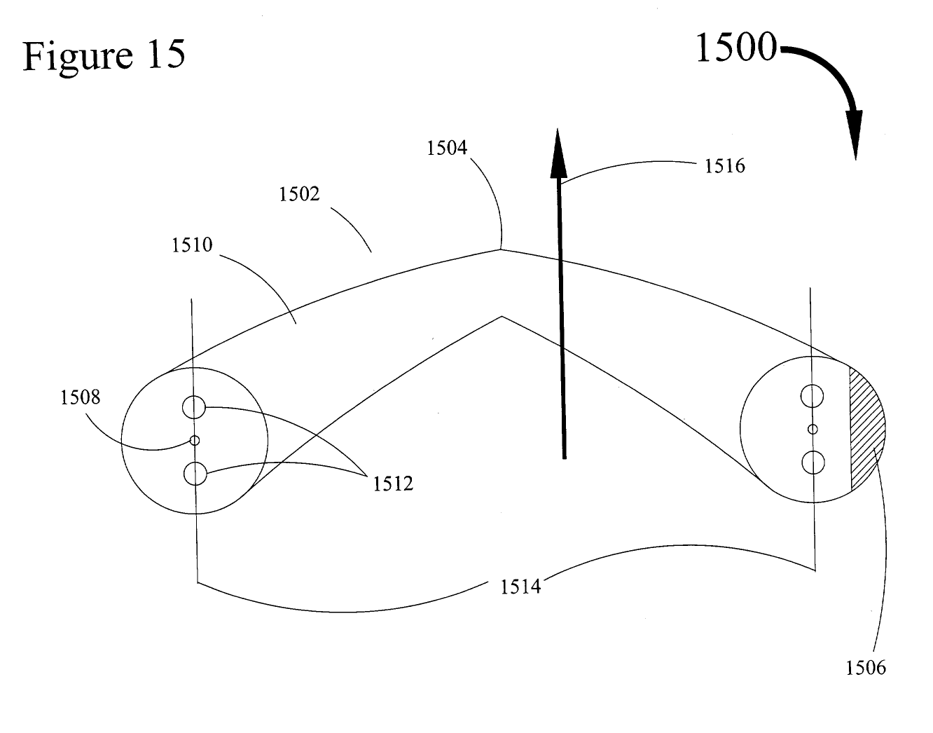

In particular, FIG. 15 shows our inventive optical fiber tap 1500 comprising polarization maintaining fiber 1502, microbend 1504 and reflecting surface 1506. Fiber 1502 is made according to the teachings of U.S. Pat. No. 4,478,489. Fiber 1502 comprises central core 1508 and surrounding cladding 1510, as with standard fiber, but in addition has two stress applying regions 1512 that are comprised of glass having a different thermal expansion coefficient than does cladding 1510. Regions 1512 create a stress field around core 1508 during manufacture with the resulting stress causing polarization modes of the fiber to have greatly different phase velocities. As a result, the two polarization modes tend not to couple energy back and forth as they propagate. The result is that polarized light will propagate in the fiber without changing its polarization.

While standard single-mode fiber is circularly symmetric about its core, polarization maintaining fibers are necessarily not circularly symmetric about the core owing to the need to generate a large difference in the phase velocities of the two polarization modes. Thus, when applying our inventive teachings to the manufacture of an optical fiber tap in polarization maintaining fiber it is preferable to place microbend 1504 and reflecting surface 1506 in a particular orientation relative to stress applying regions 1512 shown in FIG. 15. If the orientation of the microbend and reflecting surface are not controlled the performance of the optical tap will vary and thus the manufacturing yield could be adversely affected.

Returning to the preferred embodiment shown in FIG. 15, microbend 1504 and reflecting surface 1506 are formed by applying CO₂ laser radiation on a side of the fiber and away from axis 1514 formed by stress applying regions 1512. This is accomplished using the apparatus 200 of FIG. 2 by bending the fiber prior to application of the laser radiation in a plane defined by vector 1516 in FIG. 15. The vector 1516 represents the perpendicular to the plane in which the fiber is bent. When properly bent, fiber axis 1514 is parallel to vector 1516.

The orientation of fiber 1502 in apparatus 200 can be controlled by making use of a dependence of bend induced loss on the orientation of the bend in polarization maintaining fiber. For example, bending standard 1550 PANDA polarization maintaining fiber made by Fujikura while operating at 1550 nm wavelength shows 13 dB loss when bent to a radius of 0.2 inches with the orientation shown in FIG. 15. However, the same radius bend only shows a 0.3 dB loss when the orientation of fiber axis 1514 is perpendicular to vector 1516. These two values of loss also represent the minimum and maximum loss for substantially all possible orientations. The large difference in loss for the two orientations results from the lower index of refraction of the stress applying regions 1512 compared to the cladding.

Returning to the method of forming optical tap 1500 of FIG. 15, fiber 1502 is loaded into clamping fixtures 210 and 212 shown in FIG. 2. As previously described for standard fiber tap 100, clamping fixture 212 is translated toward clamping fixture 210 to form a bend in the direction of CO₂ laser 202. While monitoring the optical power transmitted through polarization maintaining fiber 1502, the orientation of the bend is varied by rolling the fiber between clamping plates 214 and 216 and clamping plates 218 and 220. This is accomplished by moving plates 214 and 218 in the direction perpendicular to the fiber axis while keeping the positions of clamping plates 216 and 220 fixed. In order to avoid twisting of the fiber and to maintain the bend direction toward the CO₂ laser, plates 214 and 218 should move in the same direction and at the same rate. Fiber 1502 is rolled until the optical power received by power meter 226 is minimum, indicating that the orientation of the bend is set for maximum loss and the fiber is bent in the orientation shown in FIG. 15. Once the orientation is set, microbend 1504 and reflecting surface 1506 are formed as described for fiber optic tap 100 of FIG. 1.

It should be noted that the method described, though applied to a specific type of polarization maintaining fiber, will work equally well for other types of polarization maintaining fibers. In general, such fibers show an asymmetry with respect to bend induced losses and thus can be formed in the same manner as described above.

Although the descriptions given above contain many detailed specifications, these should not be construed as limitations on the scope of the invention but merely as illustrations of various embodiments. For example, alternative embodiments could use a reflecting surface that is angled below the angle for total internal reflection in order to create an optical tap that is highly polarization sensitive. Such taps would be useful for polarization sensors in fiber optic systems. Also, alternative embodiments could make use of thin-film coatings on the reflecting surface 106 of FIG. 1 to provide a wide variety of wavelength dependencies in the sensitivity of the optical tap. Alternative embodiments could also make use of multiple microbends to create resonant coupling to cladding modes in a manner analogous to the phase gratings of FIG. 11.

What is claimed is:

1. A fiber optic tap for transferring optical energy out of an optical fiber, the tap comprising:
an optical fiber containing a core and a cladding;
a structure that induces cladding modes within said optical fiber; and
a reflecting surface formed in the cladding of said optical fiber for reflecting said cladding modes out of the side of said fiber.

2. The fiber optic tap in claim 1 wherein said structure comprises a microbend formed in said optical fiber.

3. The fiber optic tap in claim 1 wherein said reflecting surface is formed by ablating the cladding material away with laser radiation.

4. The fiber optic tap in claim 1 wherein said structure comprises a misaligned fusion splice.

5. The fiber optic tap in claim 1 wherein said structure comprises a periodic deformation of said optical fiber.

6. The fiber optic tap in claim 1 wherein said structure comprises a phase grating induced in said optical fiber.

7. The fiber optic tap in claim 1 wherein said reflecting surface is positioned at an angle greater than or equal to 44 degrees relative to a perpendicular to a longitudinal axis of the optical fiber.

8. The fiber optic tap of claim 1 wherein said optical fiber is a polarization maintaining single-mode fiber.

9. A bi-directional fiber optic tap for transferring optical energy out of an optical fiber comprising:
an optical fiber containing a core and a cladding;
a structure that induces cladding modes within said optical fiber; and
two reflecting surfaces formed in the cladding of said optical fiber for reflecting said cladding modes out of a side of said fiber wherein said structure is located between said reflecting surfaces.

10. The fiber optic tap in claim 9 wherein said structure comprises a microbend formed in said optical fiber.

11. The fiber optic tap in claim 9 wherein said reflecting surface is formed by ablating the cladding material away with laser radiation.

12. The fiber optic tap in claim 9 wherein said structure comprises a misaligned fusion splice.

13. The fiber optic tap in claim 9 wherein said structure comprises a periodic deformation of said optical fiber.

14. The fiber optic tap in claim 9 wherein said structure comprises a phase grating induced in said optical fiber.

15. The fiber optic tap in claim 9 wherein said reflecting surface is positioned at an angle greater than or equal to 44 degrees relative to a perpendicular to a longitudinal axis of the optical fiber.

16. The fiber optic tap of claim 9 wherein said optical fiber is a polarization maintaining single-mode fiber.

17. Apparatus for measuring optical power carried by an optical fiber, said apparatus comprising:
a housing;
an optical fiber extending longitudinally through said housing;
a structure that induces cladding modes within said optical fiber;
a reflecting surface formed in the cladding of said optical fiber for reflecting said cladding modes out of a side of said fiber; and
a detector contained within said housing and in optical communication with said reflecting surface.

18. The apparatus in claim 17 wherein said structure comprises a microbend formed in said optical fiber.

19. The apparatus in claim 17 wherein said reflecting surface is formed by ablating the cladding material away with laser radiation.

20. The apparatus in claim 17 wherein said structure comprises a misaligned fusion splice.

21. The apparatus in claim 17 wherein said structure comprises a periodic deformation of said optical fiber.

22. The apparatus in claim 17 wherein said structure comprises a phase grating induced in said optical fiber.

23. The apparatus in claim 17 wherein said reflecting surface is positioned at an angle greater than or equal to 44 degrees relative to a perpendicular to a longitudinal axis of the optical fiber.

24. The apparatus of claim 17 wherein said optical fiber is a polarization maintaining single-mode fiber.

25. Apparatus for measuring optical power being carried by an optical fiber comprising:
a tube;
an optical fiber extending longitudinally through said tube;
electrical leads extending longitudinally through said tube;
a structure that induces a portion of said optical power to be redirected out of the side of said optical fiber;
a detector contained within said tube and in electrical communication with said electrical leads and in optical communication with said structure.

26. The apparatus of claim 25 wherein said structure is the fiber optic tap of claim 1.
